(19) United States
(12) Patent Application Publication
(10) Pub. No.: US 2004/0218399 A1
(43) Pub. Date: Nov. 4, 2004

(54) Vehicle lighting device

(76) Inventor: Sung-Nan Lin, Taipei (TW)

Correspondence Address: Keith Kline, PRO-TECHTOR INTERNATIONAL SERVICES, 20775 Norada Court, Saratoga, CA, 95070-3018, US

(21) Appl. No.: 10/835,352

(22) Filed: Apr. 28, 2004

(30) Foreign Application Priority Data
Apr. 29, 2003 (TW) 92206860

(51) Int. Cl. F21S 4/00

(52) U.S. Cl. 362/509

(57) ABSTRACT

A vehicle lighting device includes a bowl-shaped reflector made of a transparent material, a main illuminating source mounted in the reflector, and a plurality of dim light sources located at a rear outer side of the reflector. The reflector has a curved and plated inner surface, and is provided on an outer surface with projected portions corresponding to the dim light sources. Rays emitted from the dim light sources are collected at the projected portions and transmitted via the transparent material of the reflector to a luminous ring formed at a front end of the reflector, so that a circle of light is shown on the vehicle lighting device to provide a visually effect warning.

### FIELD OF THE INVENTION

The present invention relates to a vehicle lighting device, which has a different structure for transmitting and radiating rays emitted from a plurality of dim light sources thereof, so as to produce a visually effective warning.

### BACKGROUND OF THE INVENTION

FIG. 1 is a crosssectional view of a conventional vehicle lighting device 1, which typically includes a reflector 11, a main lamp bulb 12, and a dim light bulb 13. A lens 14 is mounted to a front end of the reflector 11 so as to cover a front opening of the reflector 11 and give the vehicle lighting device 1 an integral appearance.

The reflector 11 is bowl-shaped member, typically made of a metal material or an opaque plastic material. The reflector 11 has a plated coating provided on an inner surface to form a curved reflecting surface 15.

The main lamp bulb 12 is a major illuminating source of the vehicle lighting device 1, and is mounted in the reflector 11 near a rear center thereof. Rays radiated from the main lamp bulb 12 are reflected by the curved reflecting surface 15 of the reflector 11 to project forward and provide the vehicle with bright illumination.

The dim light bulb 13 is a dim light source for the vehicle lighting device 1, and is mounted in the reflector 11 at one side of the main lamp bulb 12. Rays radiated from the dim light bulb 13 are also reflected by the reflecting surface 15 of the reflector 11 to project forward. The dim light bulb 13 is a low-wattage bulb having relatively low brightness for producing a warning effect when the vehicle stays in a dark or gloomy environment, such as at dawn or at dusk.

It is tried by the inventor to provide the vehicle lighting device with a dim light source that has a structure and illuminating manner different from that of the dim light source for the above-described conventional vehicle lighting device 1, so as to provide a good and visually effective warning when the vehicle stays in a dark or gloomy environment.

### SUMMARY OF THE INVENTION

A primary object of the present invention is to provide a vehicle lighting device that includes a bowl-shaped reflector made of a transparent material, a main illuminating source mounted in the reflector, and a plurality of dim light sources located at a rear outer side of the reflector. The reflector has a curved and plated inner surface, and is provided on an outer surface with projected portions corresponding to the dim light sources. Rays emitted from the dim light sources are collected at the projected portions and transmitted via the transparent material of the reflector to a luminous ring formed at a front end of the reflector, so that a circle of light is shown on the lamp to provide a visually effect warning.

The luminous ring has a front-end surface formed of a plurality of successive outward grooved surfaces for controlling angles at which rays are radiated from the luminous ring. The successive outward grooved surfaces of the luminous ring are also useful in diffusing and evenly distributing the rays radiated from the luminous ring to obtain an enhanced warning effect.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a cross sectional view of a conventional vehicle lighting device;

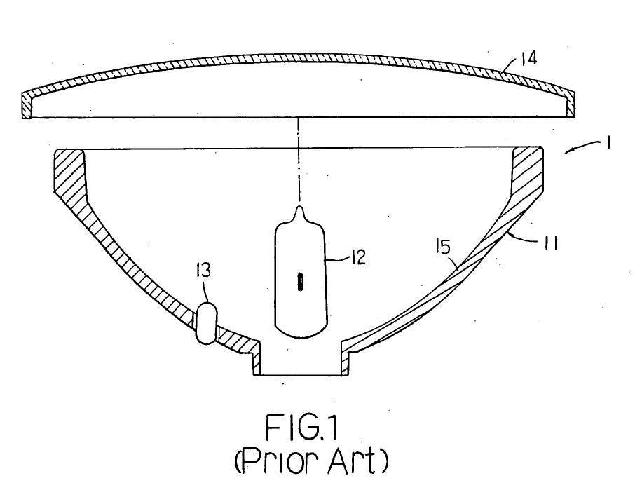

FIG. 2 is a front view of a vehicle lighting device according to an embodiment of the present invention; and

FIG. 3 is a cross sectional view of the vehicle lighting device of FIG. 2.

### DETAILED DESCRIPTION OF THE PREFERRED EMBODIMENTS

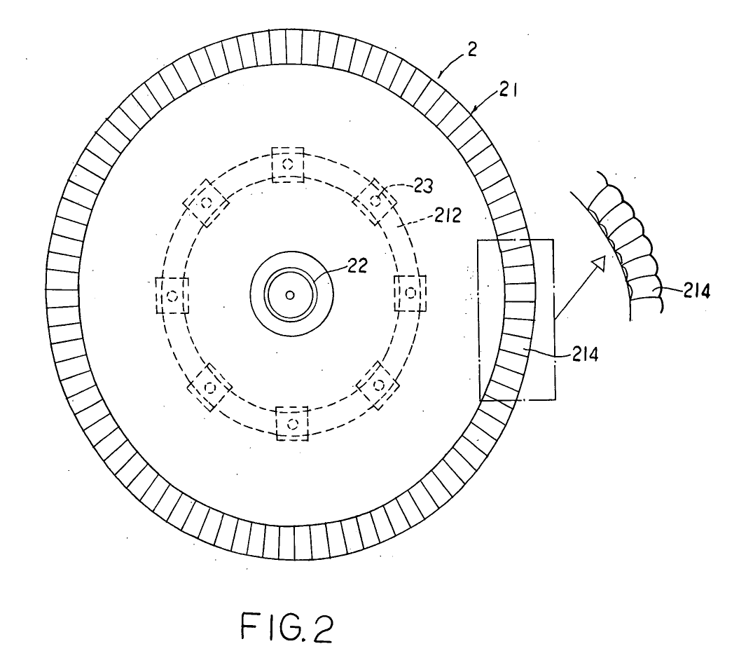

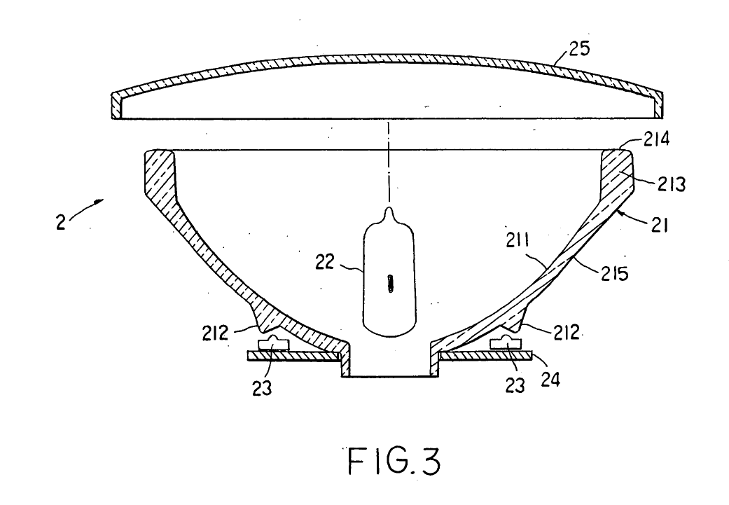

Please refer to FIGS. 2 and 3 that are front and cross sectional views, respectively, of a vehicle lighting device 2 according to an embodiment of the present invention. As shown, the vehicle lighting device 2 mainly includes a reflector 21, a main illuminating source 22, and a plurality of dim light sources 23.

The main illuminating source 22 may be, for example, a bulb mounted near a rear center in the reflector 21. The dim light sources 23 maybe, for example, a plurality of light emitting diodes, each of which is mounted on a circuit board 24 to locate at an outer side of the reflector 21 near a rear portion thereof. In the illustrated embodiment, the dim light sources 23 are circumferentially spaced from one another.

The reflector 21 is a bowl-shaped member made of a transparent material. An inner curved surface of the reflector 21 is provided with a plated coating to form a curved reflecting surface 211. The reflector 21 is provided on an outer surface with a plurality of outward projected light-collecting portions 212 corresponding to the dim light sources 23 for collecting rays emitted from the dim light sources 23. The collected rays are transmitted via the transparent material of the reflector 21 to a luminous ring 213 formed at a front portion of the reflector 21. Alternatively, the light-collecting portions 212 corresponding to the dim light sources 23 may be successively arranged to form an annular projection.

When the vehicle lighting device 2 of the present invention is turned on, the inner curved reflecting surface 211 of the reflector 21 reflects and therefore forward projects rays emitted from the main illuminating source 22 to provide the vehicle with a main illuminating device. In the event the vehicle is staying in a dark or gloomy environment, such as at dawn or dusk, and only the dim. light sources 23 are needed to provide a warning, the vehicle lighting device 2 may be switched on for the light-collecting portions 212 outside the reflector 21 to collect rays emitted from the dim light sources 23, so that the collected rays may be transmitted via the transparent material of the reflector 21 to the luminous ring 213 at the front portion of the bowl-shaped reflector 21. That is, rays emitted from the dim light sources 23 reach at the luminous ring 213 and radiate therefrom to show on the vehicle lighting device 2 a circle of light strong enough to provide a visually effective warning.

A front-end surface of the luminous ring 213 on the reflector 21 is formed of a plurality of successive outward grooved surfaces 214 for controlling angles at which rays are radiated from the luminous ring 213. The successive grooved surfaces 214 are also useful in diffusing and evenly distributing rays radiated from the luminous ring 213 to provide an enhanced warning effect.

It is to be noted that the outer surface of the reflector 21 between the light-collecting portion 212 and the luminous ring 213 has a plated coating 215 and is therefore not pervious to light. That is, both the inner and the outer surface of the reflector 21 are not pervious to light, enabling rays emitted from the dim light sources 23 and collected at the light-collecting portion 212 to be completely reflected and transmitted within and via a wall of the reflector 21 to the luminous ring 213 at the front portion of the reflector 21 and be forward radiated therefrom.

A lens 25 is mounted to cover a front opening of the reflector 21, and maintain the whole vehicle lighting device 2 in an integral appearance.

In brief, the present invention provides a vehicle lighting device having a plurality of dim light sources provided at an outer side of a bowl-shaped reflector.

Rays emitted from the dim light sources are collected by and transmitted via the reflector to a front luminous ring to show a circle of light, which is strong enough to provide a visually effective warning.

What is claimed is:

1. A vehicle lighting device comprising:
a bowl-shaped reflector made of a transparent material, said reflector being provided on an inner curved surface with a plated coating to form a curved reflecting surface, and on an outer surface at predetermined positions with a plurality of outward projected light-collecting portions, rays collected by said light-collecting portions being transmitted via said transparent material of said reflector to a luminous ring formed at a front portion of said reflector to show a circle of light thereat;
a main illuminating source mounted in said reflector near a rear central portion thereof, so that rays emitted from said main illuminating source are reflected from said inner curved reflecting surface of said reflector and be projected forward; and
a plurality of dim light sources separately mounted on circuit boards and located at positions corresponding to said light-collecting portions, and rays emitted from said dim light sources being collected by said light-collecting portions of said reflector and transmitted via said transparent material of said reflector to said luminous ring to radiate therefrom.

2. The vehicle lighting device as claimed in claim 1, wherein said light-collecting portions and said dim light sources are provided on an outer surface and at an outer side, respectively, of said reflector near a rear portion thereof.

3. The vehicle lighting device as claimed in claim 1, wherein both said light-collecting portions and said dim light sources are circumferentially spaced outside said reflector.

4. The vehicle lighting device as claimed in claim 3, wherein said light-collecting portions are successively connected to form an annular projection.

5. The vehicle lighting device as claimed in claim 1, wherein said dim light sources are light emitting diodes.

6. The vehicle lighting device as claimed in claim 1, wherein said luminous ring of said reflector has a front-end surface formed of a plurality of outward grooved surfaces.

7. The vehicle lighting device as claimed in claim 6, wherein said a plurality of outward grooved surfaces of said luminous ring are successively arranged.

8. The vehicle lighting device as claimed in claim 1, wherein said reflector is provided on an outer surface at a area between said light-collecting portions and said luminous ring with a plated coating.
